(19) United States
(12) Patent Application Publication
(10) Pub. No.: US 2019/0180403 A1
(43) Pub. Date: Jun. 13, 2019

(54) SYSTEM AND METHOD FOR VEHICLE ALLOCATION TO PASSENGERS

(71) Applicant: ANI TECHNOLOGIES PRIVATE LIMITED, Bengaluru (IN)

(72) Inventors: Moiaz Jiwani, Bilaspur (IN); Azimul Mannan, Bengaluru (IN)

(21) Appl. No.: 15/916,049

(22) Filed: Mar. 8, 2018

(30) Foreign Application Priority Data
Dec. 7, 2017 (IN) 201741043833

(51) Int. Cl. G06Q 50/30; G06Q 10/02; G06Q 10/06

(52) U.S. Cl. CPC G06Q 50/30; G06Q 50/01; G06Q 10/06315; G06Q 10/02

(57) ABSTRACT

A method and a system for allocating vehicles to passengers are provided. A first request is received from a passenger device of a passenger for booking a ride. The first request is processed to select a vehicle from a set of vehicles. Based on the selected vehicle, first and second user interfaces are rendered on the passenger and driver devices, respectively. The first and second user interfaces include a plurality of options, and verification information of the driver and the passenger, respectively. Further, second and third requests are received from the passenger and driver device, respectively, by means of the plurality of options based on the rendered verification information. The second and third requests are processed to determine first and second preferences for the allocation that optimize safety and trust of the passenger and the driver during the ride.

### CROSS-RELATED APPLICATIONS

This application claims priority of Indian Application Serial No. 201741043833, filed Dec. 7, 2017, the contents of which are incorporated herein by reference.

### FIELD OF THE INVENTION

The present invention relates generally to a vehicle allocation system, and more particularly, to a method and a system for optimizing individual's safety and trust in a vehicle allocation system.

### BACKGROUND

Generally, passengers avail various public and private transportation services for making trips to and from work places, or when the passengers are engaged in personal activities. In modern cities, vehicle transit systems play an important role by providing on-demand vehicle services to the passengers to travel to their desired destination locations. Although the vehicle transit systems prove to be useful for travelling to the desired destination locations at a desired time, using the vehicle services from unknown and untrusted vehicle transit systems involves high risks of life and security.

Conventionally, a passenger contacts personnel of a vehicle transit system, and requests for a vehicle to travel from a source location to a desired destination location. The personnel confirms an availability of the vehicle, and thereafter, allocates the vehicle to the passenger. However, during the process of the allocation, the passenger is oblivious to historical data (e.g., criminal or fraud activities, valid citizenship, or the like) of a driver of the allocated vehicle. Similarly, the driver of the allocated vehicle is oblivious to historical data (e.g., criminal or fraud activities, valid citizenship, or the like) of the passenger. As a result, there exists a sense of insecurity in the minds of the passenger and the driver during a ride due to a lack of valid, trusted, and sufficient information about the driver and the passenger, respectively.

With increased popularity of smart electronic devices, the allocation of the vehicle to the passenger by the vehicle transit system has seen a tremendous improvement. Now-a-days, the vehicle transit system provides an online platform for allocating the vehicle to the passenger. The online platform offers various services, by which the passenger is able to select a type of the vehicle, a type of service, a time of travel, and the like. Based on the information provided by the passenger, an available vehicle is allocated to the passenger. After the allocation, the vehicle transit system (via the online platform) provides driver and vehicle details, such as a name of the driver, a driver rating, a contact number of the driver, a vehicle number, or a type of the vehicle, to the passenger. Similarly, the vehicle transit system provides passenger and booking details, such as a name of the passenger, a pick-up location, or a drop-off location, to the driver. Though the use of technology has definitely eased out the burden of the vehicle allocations, the passenger and the driver are still oblivious to trusted and validated historical data about each other, and hence, the problem of the security and the trust of the passenger and the driver still exists. Such insecurities in the minds of the passenger and the driver can demotivate them from using the vehicle services of the vehicle transit system. Such actions may result in reduced footfall of the passengers for the vehicle services, and hence, loss of jobs for many drivers.

In light of the foregoing, there exists a need for a technical and more reliable solution that solves the above-mentioned problems and manages the allocation of the vehicle to the passenger that optimizes safety and trust of the passenger and the driver during the ride.

### SUMMARY

In an embodiment of the present invention, a method for allocating vehicles to passengers for optimizing safety and trust of the passengers during rides is provided. The method comprises receiving a first request for booking a ride. The first request is received from a passenger device of a passenger over a communication network. The method further comprises processing the first request to select a vehicle from a set of vehicles available for the ride. The method further comprises rendering a user interface including verification information of a driver of the selected vehicle and a plurality of options selectable by the passenger. The user interface is rendered on a display of the passenger device. The method further comprises receiving a second request from the passenger device in response to a selection by the passenger by means of the plurality of options. The passenger performs the selection based on the verification information rendered on the user interface. The method further comprises processing the second request to determine a preference of the passenger. Based on the determined preference, the selected vehicle is allocated to the passenger that optimizes the safety and trust of the passenger during the ride.

In another embodiment of the present invention, a method for allocating vehicles to passengers for optimizing safety and trust of drivers during rides is provided. The method comprises receiving a first request for booking a ride. The first request is received from a passenger device of a passenger over a communication network. The method further comprises processing the first request to select a vehicle from a set of vehicles available for the ride. The method further comprises rendering a user interface including verification information of the passenger and a plurality of options selectable by a driver of the selected vehicle. The user interface is rendered on a display of a driver device of the driver of the selected vehicle. The method further comprises receiving a second request from the driver device in response to a selection by the driver of the selected vehicle by means of the plurality of options. The driver performs the selection based on the verification information rendered on the user interface. The method further comprises processing the second request to determine a preference of the driver. Based on the determined preference, the selected vehicle is allocated to the passenger that optimizes the safety and trust of the driver during the ride.

In another embodiment of the present invention, a system for allocating vehicles to passengers for optimizing safety and trust of the passengers during rides is provided. The system comprises circuitry that is configured to receive a first request for booking a ride from a passenger device of a passenger over a communication network. The circuitry is further configured to process the first request to select a vehicle from a set of vehicles available for the ride. The circuitry is further configured to render a user interface on a display of the passenger device over the communication network. The user interface includes verification information of a driver of the selected vehicle and a plurality of options selectable by the passenger. The circuitry is further configured to receive a second request from the passenger device over the communication network. The second request is received in response to a selection by the passenger by means of the plurality of options. The passenger performs the selection based on the verification information rendered on the user interface. The circuitry is further configured to process the second request to determine a preference of the passenger. Based on the determined preference, the circuitry is further configured to allocate the selected vehicle to the passenger that optimizes the safety and trust of the passenger during the ride.

In another embodiment of the present invention, a system for allocating vehicles to passengers for optimizing safety and trust of drivers during rides is provided. The system comprises circuitry that is configured to receive a first request for booking a ride from a passenger device of a passenger over a communication network. The circuitry is further configured to process the first request to select a vehicle from a set of vehicles available for the ride. The circuitry is further configured to render a user interface on a display of a driver device of a driver of the selected vehicle over the communication network. The user interface includes verification information of the passenger and a plurality of options selectable by the driver. The circuitry is further configured to receive a second request from the driver device over the communication network. The second request is received in response to a selection by the driver by means of the plurality of options. The driver performs the selection based on the verification information rendered on the user interface. The circuitry is further configured to process the second request to determine a preference of the driver. Based on the determined preference, the circuitry is further configured to allocate the selected vehicle to the passenger that optimizes the safety and trust of the driver during the ride.

Various embodiments of the present invention provide methods and systems for allocating vehicles to passengers for optimizing safety and trust of the passengers and drivers during rides. The system comprises circuitry that is configured to receive a first request from a passenger device of a passenger over a communication network. The first request corresponds to a request for booking a ride by the passenger. The circuitry is further configured to process the first request to select a vehicle from a set of vehicles available for the ride. In an embodiment, the circuitry is further configured to render a first user interface on a first display of the passenger device over the communication network. In another embodiment, the circuitry is further configured to render a second user interface on a second display of a driver device of a driver of the selected vehicle over the communication network. The first and second user interfaces present verification information of the driver and passenger, respectively. Each of the first and second user interfaces further include a plurality of options selectable by the passenger and driver, respectively. In an embodiment, the plurality of options comprise at least two options from a first option, a second option, or a third option. The first option corresponds to an acceptance of the selected vehicle for the allocation. The second option corresponds to a rejection of the selected vehicle for the allocation. The third option corresponds to a request for re-verification. The verification information comprises at least one or more types of verifications such as an identity verification, a criminal record verification, or a background verification. The verification information further comprises at least one of a verification status of each of the one or more types of verifications or a verification time of each of the one or more types of verifications.

In an embodiment, the circuitry is configured to execute the one or more types of verifications at one or more trigger points. The one or more trigger points comprise at least one of first through seventh trigger points. The first trigger point is detected based on a registration of at least one of the driver or the passenger on a vehicle transit platform that provides vehicle services to the passenger. The second trigger point is detected based on a change in geo-fence of at least one of the driver or the passenger. The third trigger point is detected after a first interval of time based on historical feedback of at least one of the driver or the passenger. The fourth trigger point is detected after a second interval of time based on demographic data of at least one of the driver or the passenger. The fifth trigger point is detected after a third interval of time based on a fraud or criminal history of at least one of the driver or the passenger. The sixth trigger point is detected based on a rating of at least one of the driver or the passenger and the demographic data. The seventh trigger point is detected based on an analysis of information associated with at least one of the driver or the passenger that has been captured from at least one of a social media platform, a newscast, or an electronic document over the communication network. In an embodiment, the circuitry is configured to execute the one or more types of verifications based on one or more types of documents of at least one of the driver or the passenger. The one or more types of documents are captured based on the one or more trigger points prior to the execution of the one or more types of verifications.

In an embodiment, the circuitry is further configured to receive a second request from the passenger device in response to a selection by the passenger by means of the plurality of options on the first user interface. The passenger performs the selection based on the verification information of the driver rendered on the first user interface. In another embodiment, the circuitry is further configured to receive a third request from the driver device in response to a selection by the driver by means of the plurality of options on the second user interface. The driver performs the selection based on the verification information of the passenger rendered on the second user interface. In an embodiment, the circuitry is further configured to process at least one of the received second or third request to determine at least one of first or second preference of the passenger or the driver, respectively. Based on at least one of the determined first or second preference, the selected vehicle is allocated to the passenger for the ride. In an embodiment, the selected vehicle is allocated to the passenger, when at least one of the determined first or second preference is associated with the first option. Further, another vehicle is selected from the set of vehicles that are available for the ride, when at least one of the determined first or second preference is associated with the second option. Further, the driver of the selected vehicle or the passenger is re-verified, when at least one of the determined first or second preference is associated with the third option, respectively. Thus, the vehicle is allocated to the passenger based on the preference of at least one of the passenger or driver, thereby, optimizing the safety and trust of the passenger and the driver during the ride.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment for allocating vehicles to passengers, in accordance with an embodiment of the present invention;

FIG. 2A is a block diagram that illustrates a passenger device and an application server of the environment of FIG. 1, in accordance with an embodiment of the present invention;

FIG. 2B is a block diagram that illustrates a driver device and an application server of the environment of FIG. 1, in accordance with another embodiment of the present invention;

FIG. 3A is a block diagram that illustrates a first user interface of FIG. 2A, in accordance with an embodiment of the present invention;

FIG. 3B is a block diagram that illustrates a second user interface of FIG. 2B, in accordance with another embodiment of the present invention;

FIG. 4 is a flow chart that illustrates a method for allocating vehicles to passengers, in accordance with an embodiment of the present invention;

FIG. 5 is a flow chart that illustrates a method for allocating vehicles to passengers, in accordance with another embodiment of the present invention; and

FIG. 6 is a block diagram that illustrates a computer system for allocating vehicles to passengers, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for allocating vehicles to passengers for optimizing safety and trust of the passengers and drivers during rides in a vehicle transit system. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A vehicle is a means of transport that is deployed by a vehicle transit system, such as a vehicle service provider, to provide vehicle services to one or more passengers. For example, the vehicle is an automobile, a bus, a car, a bike, or the like. The passengers may travel in the vehicle to commute between a plurality of locations including source and destination locations. Hereinafter, various methods of providing the vehicle services to the one or more passengers by the vehicle transit system have been described that will become apparent to a person having ordinary skill in the relevant art.

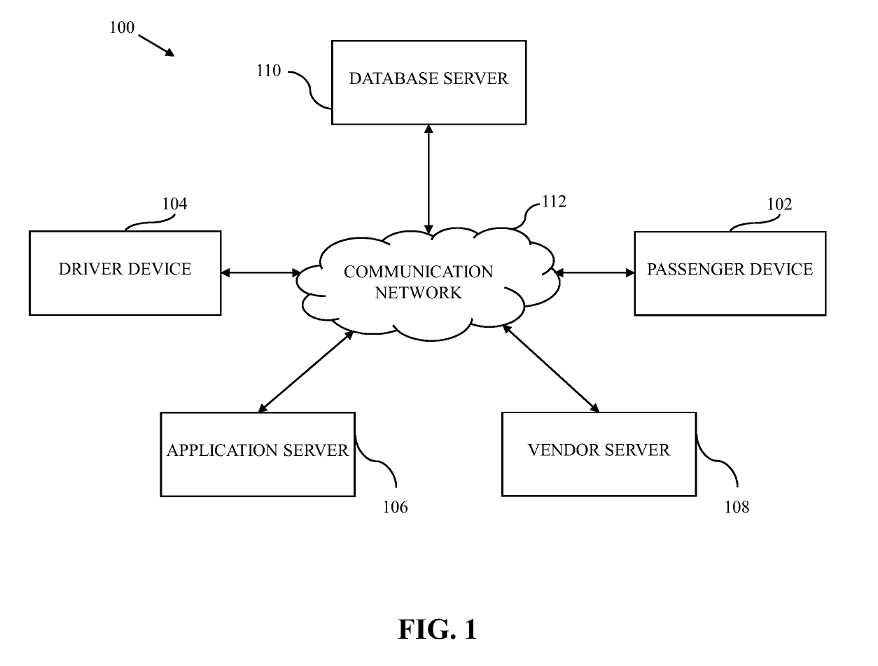

Referring now to FIG. 1, a block diagram that illustrates an environment 100 for allocating vehicles to passengers is shown, in accordance with an embodiment of the present invention. The environment 100 includes a passenger device 102, a driver device 104, an application server 106, a vendor server 108, and a database server 110 that communicate with each other by way of a communication network 112. Examples of the communication network 112 include, but are not limited to, wireless fidelity (Wi-Fi) network, a light fidelity (Li-Fi) network, a satellite network, the Internet, a mobile network such as cellular data, high speed packet access (HSPA), or any combination thereof.

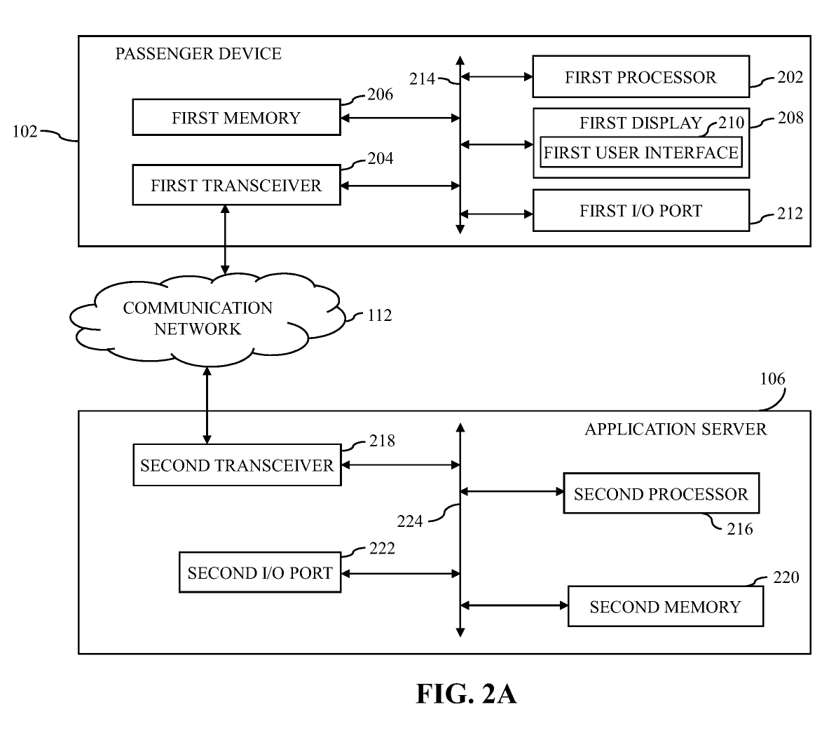

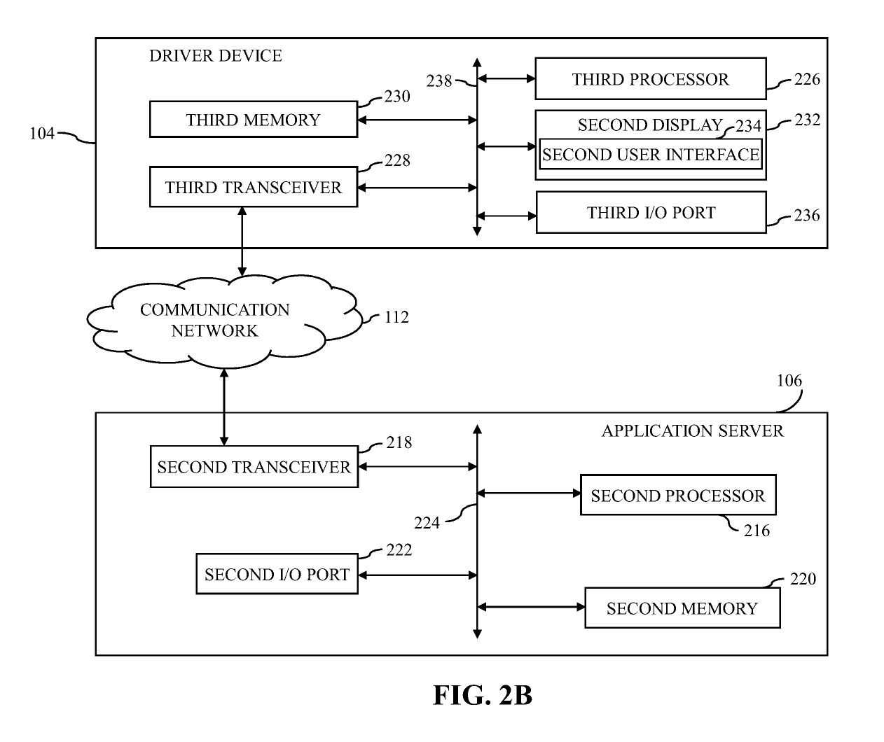

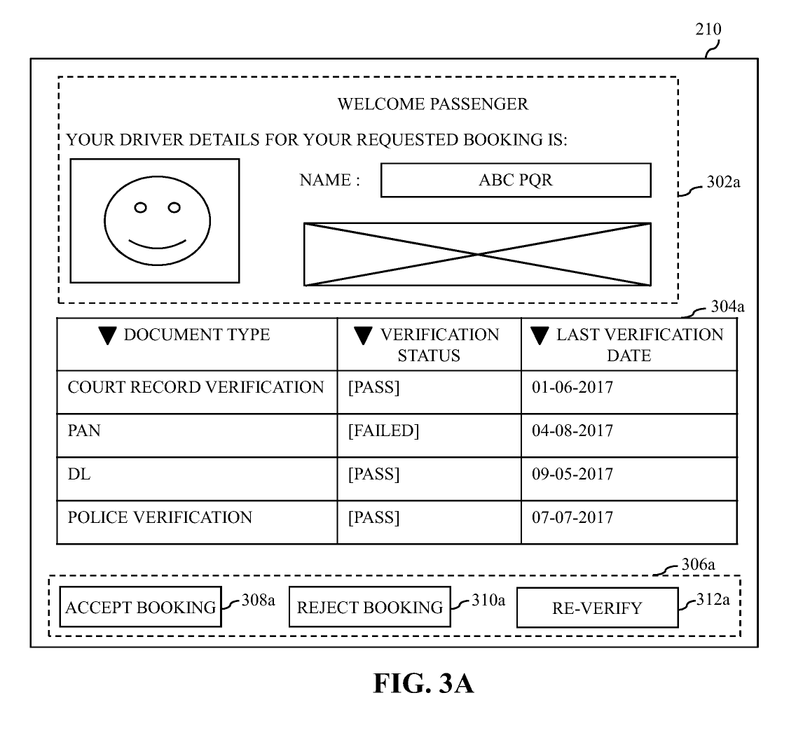

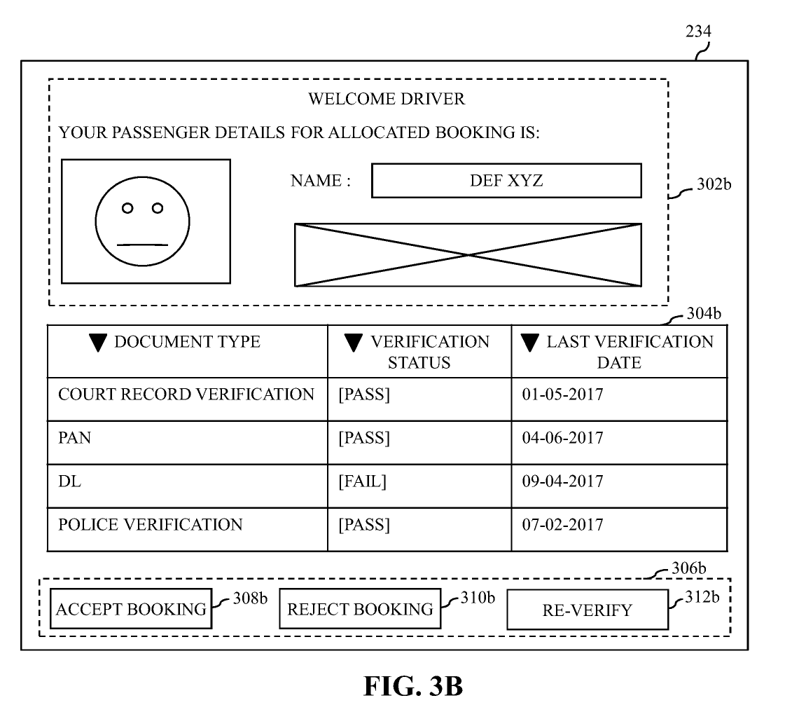

The passenger device 102 is a computing device that is utilized by the passenger to perform one or more activities. For example, the passenger utilizes the passenger device 102 to transmit a booking request for a ride between a plurality of locations including source and destination locations by means of a service application installed on the passenger device 102. To schedule the ride, the passenger inputs details of the booking request including at least one of the source location, the destination location, a vehicle type, a time of travel, or the like by means of the installed service application. In a scenario when a pick-up location of the passenger is the same as the source location, the passenger may not provide the source location. In such a scenario, a source address of the source location is automatically captured by the application server 106 based on Global Positioning System (GPS) information transmitted by the passenger device 102 over the communication network 112. However, if the pick-up location is different from the captured source address, the passenger may provide the pick-up address. The passenger further utilizes the passenger device 102 to view verification information of a driver of a vehicle that has been selected for the ride by the application server 106. Based on the verification information, the passenger may accept or reject the selected vehicle for the allocation. The passenger may further initiate a re-verification of the driver prior to accepting or rejecting the selected vehicle for the allocation. Examples of the passenger device 102 include, but are not limited to, a personal computer, a laptop, a smartphone, a tablet computer, and the like. The passenger device 102 has been described in detail in conjunction with FIGS. 2A and 3A.

The driver device 104 is a computing device that is utilized by the driver of the selected vehicle to perform one or more activities. For example, the driver utilizes the driver device 104 to view an upcoming booking request that has been directed by the application server 106 based on the received booking request from the passenger device 102. The driver further utilizes the driver device 104 to view verification information of the passenger associated with the received booking request. Based on the verification information, the driver may accept or reject the received booking request. The driver may further initiate a re-verification of the passenger prior to accepting or rejecting of the received booking request. The driver further utilizes the driver device 104 to view a route between the source and destination locations provided by the application server 106 or a third-party server (not shown) over the communication network 112. In an exemplary embodiment, the driver device 104 may be a vehicle head unit. In another exemplary embodiment, the driver device 104 may be a communication device, such as a smartphone, a personal digital assistant (PDA), a tablet, or any other portable communication device, that is placed in the vehicle. The driver device 104 has been described in detail in conjunction with FIGS. 2B and 3B.

The application server 106 is a computing device, a software framework, or a combination thereof, that may provide a generalized approach to create the application server implementation. In an embodiment, the operation of the application server 106 may be dedicated to execution of procedures, such as, but not limited to, programs, routines, or scripts stored in one or more memories for supporting its applied applications. In an embodiment, the application server 106 receives the booking request from the passenger device 102 over the communication network 112. The application server 106 processes the booking request to select the vehicle from a set of vehicles available for the ride. Further, the application server 106 renders a user interface on at least one of the passenger device 102 or the driver device 104 over the communication network 112. The user interface on the passenger device 102 may present the verification information of the driver of the selected vehicle. The user interface on the driver device 104 may present the verification information of the passenger. The user interface may further present a plurality of options selectable by the passenger or the driver. The passenger or the driver may perform a selection based on the verification information rendered on the user interface of the passenger device 102 or the driver device 104, respectively. In response to the selection by at least one of the passenger or the driver by means of the plurality of options, the application server 106 determines a preference of at least one of the passenger or the driver for the allocation that optimizes the safety and trust of the passenger or the driver during the ride. Examples of the application server 106 include, but are not limited to, a personal computer, a laptop, or a network of computer systems. The application server 106 may be realized through various web-based technologies such as, but not limited to, a Java web-framework, a .NET framework, a PHP framework, or any other web-application framework. The various operations of the application server 106 have been described in detail in conjunction with FIGS. 2A, 2B, 3A, and 3B.

The vendor server 108 is a computing device or a network of computing devices that stores and manages verification data, such as identity information, criminal records, background information, or the like, of one or more individuals, for example, the passenger or the driver. In an exemplary embodiment, the vendor server 108 is managed and controlled by a government official, a security personnel (e.g., a police officer), a jurisdiction entity (e.g., a court body), a law firm handling different types of lawsuits, or the like. In another exemplary embodiment, the vendor server 108 is managed and controlled by a third party entity, who may communicate with the government official, the security personnel, the jurisdiction entity, the law firm, or the like to obtain and store the verification data, the criminal records, the background information, or the like of the one or more individuals. In an embodiment, the vendor server 108 may receive a query from the application server 106 over the communication network 112 to retrieve verification information of the passenger or the driver. The verification information may be associated with the identity information, the criminal records, the background information, the court records, the legal documents, or the like. In response to the received query, the vendor server 108 extracts and transmits the requested information to the application server 106 or the database server 110 over the communication network 112. Examples of the vendor server 108 include, but are not limited to, a personal computer, a laptop, or a network of computer systems.

The database server 110 is a data management and storage server that manages and stores passenger information of one or more passengers (such as the passenger who has requested for the ride) and driver information of one or more drivers (such as the driver who has been selected for the requested booking). The database server 110 includes a processor (not shown) and a memory (not shown) for managing and storing the passenger and driver information. In an embodiment, for managing and storing the passenger and driver information, the processor captures one or more types of documents (i.e., electronic documents) of the passenger and the driver from at least one of the passenger device 102, the driver device 104, the application server 106, or the vendor server 108, and stores in the memory. In another embodiment, for managing and storing the passenger and driver information, the processor extracts (or retrieves) the verification information of the passenger and the driver from at least one of the passenger device 102, the driver device 104, the application server 106, or the vendor server 108, and stores in the memory. The verification information may include at least one or more types of verifications, a verification status of each of the one or more types of verifications, or a verification time of each of the one or more types of verifications. The one or more types of verifications include at least one of an identity verification, a criminal record verification, or a background verification. The one or more types of verifications may be executed by the application server 106 based on the one or more types of documents of the passenger or the driver. For example, the one or more types of documents may be one or more of an identity document (e.g., a passport, a voter identifier (ID), an Aadhaar ID, a social security ID, or the like), an address proof document (e.g., a rent agreement document, a utility bill document, a house ownership document, a property ownership document, or the like), a driving license, an academic document (e.g., a primary, secondary, or high school certificate), a tax-related document (e.g., a permanent account number (PAN), or the like), or a judiciary-verified document (e.g., a police-verified affidavit, a court-verified affidavit, or the like). A person having ordinary skill in the art will understand that the one or more types of documents may vary from one geographical location to another geographical location without limiting the scope of the present invention. In another embodiment, for managing and storing the passenger and driver information, the processor receives historical travel data of the passenger and the driver, and stores in the memory. The historical travel data of the passenger includes historical travel requests by the passenger, historical booking cancellations by the passenger, historical feedback of the passenger, or the like. The historical travel data of the driver includes historical travel supplies by the driver, historical booking cancellations by the driver, historical feedback of the driver, or the like. In another embodiment, for managing and storing the passenger and driver information, the processor receives social media data or newscast data of the passenger and the driver from one or more social media platforms or newscasts, and stores in the memory. Further, in an embodiment, the database server 110 may receive a query from the application server 106 over the communication network 112, to retrieve the passenger and driver information, for example, the one or more types of documents, the verification information, the historical travel data, or the like. The database server 110, in response to the received query from the application server 106, transmits the requested information to the application server 106 over the communication network 112. Examples of the database server 110 include, but are not limited to, a personal computer, a laptop, or a network of computer systems.

Referring now to FIG. 2A, a block diagram that illustrates the passenger device 102 and the application server 106 of the environment 100 of FIG. 1 is shown, in accordance with an embodiment of the present invention. The passenger device 102 includes circuitry such as, a first processor 202, a first transceiver 204, a first memory 206, a first display 208 comprising a graphical user interface (GUI) such as a first user interface 210, and a first input/output (I/O) port 212 that communicate with each other by way of a first communication bus 214. The application server 106 includes circuitry such as, a second processor 216, a second transceiver 218, a second memory 220, and a second I/O port 222 that communicate with each other by way of a second communication bus 224.

The first processor 202 includes suitable logic, circuitry, and/or interfaces that are operable to execute one or more instructions stored in the first memory 206 to perform one or more operations. For example, the first processor 202 transmits a first request to the second processor 216 by way of the first transceiver 204 over the communication network 112. The first request may be a booking request provided by the passenger for booking the ride between the source and destination locations. The first request may include at least one of the source location, the destination location, the vehicle type, the time of travel, or the like. The first processor 202 further captures and transmits the GPS information of the passenger device 102 by means of one or more location-capturing sensors (not shown) embedded inside the passenger device 102. The first processor 202 further receives the first user interface 210 from the second processor 216 by means of the first transceiver 204 over the communication network 112, and renders the first user interface 210 on the first display 208 by means of the first communication bus 214. The first user interface 210 presents the verification information of the driver of the vehicle selected by the second processor 216 in response to the received first request. The first user interface 210 further presents the plurality of options selectable by the passenger to perform one or more actions corresponding to each of the plurality of options. The plurality of options include at least two options from the first through third options. The first option corresponds to an acceptance of the selected vehicle for the allocation. The second option corresponds to a rejection of the selected vehicle for the allocation. The third option corresponds to a request for the re-verification of the driver. Based on the verification information and the plurality of options on the first user interface 210, the passenger provides an input by way of the first I/O port 212 to transmit a second request to the second processor 216 over the communication network 112. The second request may indicate the preference of the passenger for the selected vehicle for the allocation. Examples of the first processor 202 include, but are not limited to, an application-specific integrated circuit (ASIC) processor, a reduced instruction set computing (RISC) processor, a complex instruction set computing (CISC) processor, or a field-programmable gate array (FPGA). It will be apparent to a person skilled in the art that the first processor 202 is compatible with multiple operating systems. It will further be apparent to a person skilled in the art that the first processor 202 may be compatible with multiple displays, for example, the first display 208 of the passenger device 102.

The first transceiver 204 includes suitable logic, circuitry, and/or interfaces that are operable to transmit (or receive) data to (or from) various devices, such as the second transceiver 218 over the communication network 112. For example, the first transceiver 204 transmits one or more requests, such as the first and second requests provided by the passenger by means of the first I/O port 212, to the second transceiver 218 over the communication network 112. The first transceiver 204 further receives one or more user interfaces, such as the first user interface 210 including the verification information of the driver of the selected vehicle and the plurality of options that are selectable by the passenger, from the second transceiver 218 over the communication network 112. The first transceiver 204 further receives allocation information of the allocated vehicle for the ride from the second transceiver 218 over the communication network 112, and stores in the first memory 206. The allocation information may include at least one of an identity name of the driver of the allocated vehicle, a vehicle identification number of the allocated vehicle, a current status of the allocated vehicle, or an expected time of arrival at the source location for the pick-up. Examples of the first transceiver 204 include, but are not limited to, an antenna, a radio frequency transceiver, a wireless transceiver, and a Bluetooth transceiver. The first transceiver 204 communicates with the communication network 112, the first processor 202, and the second transceiver 218 using various wired and wireless communication protocols, such as TCP/IP (Transmission Control Protocol/Internet Protocol), UDP (User Datagram Protocol), 2^{nd} Generation (2G), 3rd Generation (3G), 4^{th} Generation (4G) communication protocols, or any combination thereof.

The first memory 206 includes suitable logic, circuitry, and/or interfaces to store the one or more instructions that are executed by the first processor 202 to perform the one or more operations. The first memory 206 further stores the one or more types of documents of the passenger. The first memory 206 further stores the verification information of the driver of the selected vehicle provided by the second processor 216 in response to the received first request. The first memory 206 further stores the allocation information of the allocated vehicle. Examples of the first memory 206 include, but are not limited to, a random access memory (RAM), a read-only memory (ROM), a programmable ROM (PROM), and an erasable PROM (EPROM).

The first display 208 includes suitable logic, circuitry, and/or interfaces that are operable to execute one or more instructions stored in the first memory 206 to perform one or more operations. For example, the first display 208 displays one or more user interfaces, such as a booking interface (not shown) associated with the installed service application based on the input provided by the passenger under the control of the first processor 202 over the communication network 112. The passenger may utilize the booking interface on the first display 208 to input the first request by means of the first I/O port 212 that is transmitted by the first processor 202 to the second processor 216 over the communication network 112. The first display 208 further displays the first user interface 210 provided by the second processor 216 under the control of the first processor 202. The passenger may utilize the first user interface 210 on the first display 208 to input the second request by means of the first I/O port 212 that is transmitted by the first processor 202 to the second processor 216 over the communication network 112. Examples of the first display 208 include, but are not limited to, TFT LCD, IPS LCD, Resistive Touchscreen LCD, Capacitive Touchscreen LCD, OLED, AMOLED, Super AMOLED, Retina Display, Haptic/Tactile touchscreen, and Gorilla Glass.

The first I/O port 212 includes suitable logic, circuitry, and/or interfaces that are operable to execute one or more instructions stored in the first memory 206 to perform one or more operations. The first I/O port 212 may include input and output devices that are configured to operate under the control of the first processor 202 by way of the first communication bus 214. For example, by means of the first I/O port 212, the passenger provides one or more inputs to perform the one or more operations. For example, the passenger may provide the one or more inputs to open the installed service application on the passenger device 102, provide and transmit at least the first and second requests for booking the ride, and the like. Examples of the input devices may include a universal serial bus (USB) port, an Ethernet port, a real or virtual keyboard, a mouse, a joystick, a touch screen, a stylus, a microphone, and the like. Examples of the output devices may include the first display 208, a speaker, headphones, a universal serial bus (USB) port, an Ethernet port, and the like.

The second processor 216 includes suitable logic, circuitry, and/or interfaces that are operable to execute one or more instructions stored in the second memory 220 to perform one or more operations. For example, the second processor 216 receives the first request from the first transceiver 204 by way of the second transceiver 218 over the communication network 112. In response to the received first request, the second processor 216 selects the vehicle from the set of vehicles available for the ride. Based on the selected vehicle, the second processor 216 extracts the verification information of the driver of the selected vehicle from the database server 110 over the communication network 112, and stores the extracted verification information in the second memory 220. The verification information includes at least the one or more types of verifications, the verification status of each of the one or more types of verifications, or the verification time of each of the one or more types of verifications. The one or more types of verifications includes at least one of the identity verification, the criminal record verification, or the background verification of the driver of the selected vehicle.

Prior to the extraction of the verification information, the second processor 216 may have executed the one or more types of verifications for the driver at one or more trigger points, and would have stored the verification information of the driver in the database server 110. The one or more trigger points include at least one of first through seventh trigger points. The second processor 216 detects the first trigger point based on a registration of the driver (i.e., at the time of on-boarding of the driver) on a vehicle transit platform that provides vehicle services to the one or more passengers. The second processor 216 detects the second trigger point based on a change in geo-fence of the driver (i.e., change in geographical locations from a first city to a second city, a first state to a second state, a first country to a second country, or the like). The second processor 216 detects the third through fifth trigger points after a first, second, or third interval of time, for example, after a defined number of hours, days, months, or years. The third trigger point is detected based on the historical feedback of the driver that had been provided by the one or more passengers based on their travel experience with the driver in the past. The fourth trigger point is detected based on demographic data of the driver (i.e., when the demographic data of the driver indicates an association of the driver with a crime-related area even if the driver has not committed any crime in the past). The fifth trigger point is detected based on a fraud or criminal history of the driver. The second processor 216 detects the sixth trigger point based on a rating of the driver and the demographic data. The second processor 216 detects the seventh trigger point based on analysis of information associated with the driver that has been captured from at least one of a social media platform, a newscast, or a published document over the communication network 112. Prior to executing the one or more types of verifications, the second processor 216 further retrieves the one or more types of documents from the database server 110 that are required for executing the one or more types of verifications. In case the one or more types of documents are unavailable in the database server 110, the second processor 216 may request the driver to provide the one or more types of documents. After retrieving the one or more types of documents, the second processor 216 may execute the one or more types of verifications at the one or more trigger points. In an embodiment, the second processor 216 may validate the one or more types of documents of the driver based on information received from one or more reliable sources, such as the vendor server 108. Based on pass or failure of the validation of the one or more types of verifications, the second processor 216 stores the verification information of the driver in the database server 110.

After extracting the verification information of the driver from the database server 110, the second processor 216 renders the first user interface 210 on the first display 208 of the passenger device 102 over the communication network 112. The first user interface 210 presents at least the verification information of the driver of the selected vehicle and the plurality of options that are selectable by the passenger to perform the one or more actions. The second processor 216 further receives the second request from the first transceiver 204 by way of the second transceiver 218 over the communication network 112. The second processor 216 processes the second request to determine the preference of the passenger. Based on the determined preference, the second processor 216 performs one or more defined operations. For example, the second processor 216 allocates the selected vehicle to the passenger, when the determined preference of the passenger is associated with the first option. The second processor 216 selects another vehicle from the set of vehicles available for the ride, when the determined preference of the passenger is associated with the second option. The second processor 216 performs the re-verification of the driver of the selected vehicle, when the determined preference of the passenger is associated with the third option. Examples of the second processor 216 include, but are not limited to, an ASIC processor, a RISC processor, a CISC processor, and a FPGA. It will be apparent to a person skilled in the art that the second processor 216 is compatible with multiple operating systems.

The second transceiver 218 includes suitable logic, circuitry, and/or interfaces that are operable to transmit (or receive) data to (or from) various devices, such as the first transceiver 204 over the communication network 112. For example, the second transceiver 218 receives the one or more requests, such as the first and second requests, from the first transceiver 204 over the communication network 112. The second transceiver 218 further transmits the one or more interfaces, such as the first user interface 210, to the first transceiver 204 over the communication network 112. The second transceiver 218 further transmits the allocation information to the first transceiver 204 over the communication network 112. Examples of the second transceiver 218 include, but are not limited to, an antenna, a radio frequency transceiver, a wireless transceiver, and a Bluetooth transceiver. The second transceiver 218 communicates with the communication network 112, the second processor 216, and the first transceiver 204 using various wired and wireless communication protocols, such as TCP/IP (Transmission Control Protocol/Internet Protocol), UDP (User Datagram Protocol), 2^{nd} Generation (2G), 3rd Generation (3G), 4^{th} Generation (4G) communication protocols, or any combination thereof.

The second memory 220 includes suitable logic, circuitry, and/or interfaces to store the one or more instruction that are executed by the second processor 216 to perform the one or more operations. The second memory 220 further stores the one or more types of documents of the driver for executing the one or more types of verifications. The second memory 220 further stores the one or more requests, such as the first and second requests. The second memory 220 further stores the verification information of the driver. The second memory 220 further stores the allocation information of the allocated vehicle to the passenger. Examples of the second memory 220 include, but are not limited to, a RAM, a ROM, a PROM, and an EPROM.

The second I/O port 222 includes suitable logic, circuitry, and/or interfaces that are operable to execute one or more instructions stored in the second memory 220 to perform one or more operations. The second I/O port 222 may include various input and output devices that are configured to operate under the control of the second processor 216 by way of the second communication bus 224. For example, by means of the second I/O port 222, an administrator associated with the application server 106 provides one or more inputs to perform the one or more operations. For example, the administrator may define the one or more trigger points by means of the second I/O port 222. Examples of the input devices may include a universal serial bus (USB) port, an Ethernet port, a real or virtual keyboard, a mouse, a joystick, a touch screen, a stylus, a microphone, and the like. Examples of the output devices may include a display screen, a speaker, headphones, a universal serial bus (USB) port, an Ethernet port, and the like.

Referring now to FIG. 2B, a block diagram that illustrates the driver device 104 and the application server 106 of the environment 100 of FIG. 1 is shown, in accordance with another embodiment of the present invention. The driver device 104 includes circuitry such as, a third processor 226, a third transceiver 228, a third memory 230, a second display 232 comprising a GUI, such as a second user interface 234, and a third I/O port 236 that communicate with each other by way of a third communication bus 238. The application server 106 includes the circuitry such as the second processor 216, the second transceiver 218, the second memory 220, and the second I/O port 222 that communicate with each other by way of the second communication bus 224.

The third processor 226 includes suitable logic, circuitry, and/or interfaces that are operable to execute one or more instructions stored in the third memory 230 to perform one or more operations. For example, the third processor 226 transmits a vehicle status of the vehicle to the second processor 216 by way of the third transceiver 228 over the communication network 112. The vehicle status indicates whether the vehicle is occupied with a current trip. For example, when the vehicle is occupied with the current trip (i.e., the driver is transporting the one or more passengers to their destination locations), then the vehicle may not be considered for the upcoming booking request. However, when the vehicle is unoccupied (i.e., there are no passengers who are travelling in the vehicle), then the vehicle may be considered for the upcoming booking request. The vehicle status further indicates whether the vehicle is within a defined time limit of finishing the current trip. For example, when the vehicle is within the defined time limit (e.g., “10” minutes) of finishing the current trip, then the vehicle may be considered for the upcoming booking request. However, when the vehicle is not with the defined time limit of finishing the current trip, then the vehicle may not be considered for the upcoming booking request. The third processor 226 further captures and transmits the GPS information of the driver device 104 by means of one or more location-capturing sensors (not shown) embedded inside the driver device 104. Based on an availability of the vehicle to take up the upcoming booking request, the third processor 226 receives the booking request (based on the first request by the passenger) from the second processor 216 by means of the third transceiver 228 over the communication network 112. The third processor 226 further receives the second user interface 234 from the second processor 216 by means of the third transceiver 228 over the communication network 112, and renders the second user interface 234 on the second display 232 by means of the third communication bus 238. The second user interface 234 presents the verification information of the passenger who has requested for the ride. The second user interface 234 further presents the plurality of options that are selectable by the driver to perform one or more actions. The plurality of options include at least two options from the first through third options. The first option corresponds to an acceptance of the booking request (i.e., the selected vehicle) for the allocation. The second option corresponds to a rejection of the booking request (i.e., the selected vehicle) for the allocation. The third option corresponds to a request for the re-verification of the passenger. Based on the verification information and the plurality of options presented on the second user interface 234, the driver provides the input by way of the third I/O port 236 to transmit a third request to the second processor 216 over the communication network 112. The third request may indicate the preference of the driver for the allocation. Examples of the third processor 226 include, but are not limited to, an ASIC processor, a RISC processor, a CISC processor, and a FPGA. It will be apparent to a person skilled in the art that the third processor 226 is compatible with multiple operating systems. It will further be apparent to a person skilled in the art that the third processor 226 may be compatible with multiple displays, for example, the second display 232.

The third transceiver 228 includes suitable logic, circuitry, and/or interfaces that are operable to transmit (or receive) data to (or from) various devices, such as the second transceiver 218 over the communication network 112. For example, the third transceiver 228 receives the booking request (based on the first request by the passenger) from the second transceiver 218 over the communication network 112. The third transceiver 228 further receives the one or more user interfaces, such as the second user interface 234, from the second transceiver 218 over the communication network 112. The second transceiver 218 further transmits the third request to the second transceiver 218 over the communication network 112. The second transceiver 218 further receives the passenger information of the passenger from the second transceiver 218 over the communication network 112. Examples of the third transceiver 228 include, but are not limited to, an antenna, a radio frequency transceiver, a wireless transceiver, and a Bluetooth transceiver. The third transceiver 228 communicates with the communication network 112, the third processor 226, and the second transceiver 218 using various wired and wireless communication protocols, such as TCP/IP (Transmission Control Protocol/Internet Protocol), UDP (User Datagram Protocol), 2^{nd} Generation (2G), 3rd Generation (3G), 4^{th} Generation (4G) communication protocols, or any combination thereof.

The third memory 230 includes suitable logic, circuitry, and/or interfaces to store the one or more instructions that are executed by the third processor 226 to perform the one or more operations. The third memory 230 further stores the one or more types of documents of the driver. The third memory 230 further stores the verification information of the passenger provided by the second processor 216 in response to the received first request. Examples of the third memory 230 include, but are not limited to, a RAM, a ROM, a PROM, and an EPROM.

The second display 232 includes suitable logic, circuitry, and/or interfaces that are operable to execute one or more instructions stored in the second memory 220 to perform one or more operations. For example, the second display 232 displays the one or more user interfaces, such as the second user interface 234 provided by the second processor 216 under the control of the first processor 202. The driver may utilize the second user interface 234 on the second display 232 to input the third request by means of the third I/O port 236 that is transmitted by the third processor 226 to the second processor 216 over the communication network 112. Examples of the second display 232 include, but are not limited to, TFT LCD, IPS LCD, Resistive Touchscreen LCD, Capacitive Touchscreen LCD, OLED, AMOLED, Super AMOLED, Retina Display, Haptic/Tactile touchscreen, and Gorilla Glass.

The third I/O port 236 includes suitable logic, circuitry, and/or interfaces that are operable to execute one or more instructions stored in the third memory 230 to perform one or more operations. The third I/O port 236 may include input and output devices that are configured to operate under the control of the third processor 226 by way of the third communication bus 238. For example, by means of the third I/O port 236, the driver provides one or more inputs to perform the one or more operations. For example, the driver may provide the one or more inputs to provide and transmit at least the third request in response to the received booking request. Examples of the input devices may include a universal serial bus (USB) port, an Ethernet port, a real or virtual keyboard, a mouse, a joystick, a touch screen, a stylus, a microphone, and the like. Examples of the output devices may include a display screen, a speaker, headphones, a universal serial bus (USB) port, an Ethernet port and the like.

The second processor 216 includes suitable logic, circuitry, and/or interfaces that are operable to execute one or more instructions stored in the second memory 220 to perform one or more operations. For example, the second processor 216 determines the availability of the set of vehicles from one or more vehicles in response to the received first request. The availability of the set of vehicles may be determined based on at least one of the vehicle status (or the GPS information) of the set of vehicles. Based on the availability of the set of vehicles, the second processor 216 selects the vehicle from the set of vehicles available for the ride request by the passenger. Further, the second processor 216 extracts the verification information of the passenger from the database server 110 over the communication network 112, and stores the extracted verification information in the second memory 220. The verification information includes at least the one or more types of verifications, the verification status of each of the one or more types of verifications, or the verification time of each of the one or more types of verifications. The one or more types of verifications includes at least one of the identity verification, the criminal record verification, or the background verification of the passenger.

Prior to the extraction of the verification information, the second processor 216 may have executed the one or more types of verifications for the passenger at the one or more trigger points, and would have stored the verification information of the passenger in the database server 110. The one or more trigger points include at least one of the first through seventh trigger points. The second processor 216 detects the first trigger point based on a registration of the passenger (i.e., at the time of on-boarding of the passenger) on the vehicle transit platform. The second processor 216 detects the second trigger point based on a change in geo-fence of the passenger (i.e., change in the geographical locations from a first city to a second city, a first state to a second state, a first country to a second country, or the like). The second processor 216 detects the third through fifth trigger points after a first, second, or a third interval of time, for example, after a defined number of hours, days, months, or years. The third trigger point is detected based on the historical feedback of the passenger that had been provided by the one or more drivers based on their travel experience with the passenger in the past. The fourth trigger point is detected based on demographic data of the passenger (i.e., when the demographic data of the passenger indicates an association of the passenger with a crime-related area even if the passenger has not committed any crime in the past). The fifth trigger point is detected based on a fraud or criminal history of the passenger. The second processor 216 detects the sixth trigger point based on a rating of the passenger and the demographic data. The second processor 216 detects the seventh trigger point based on analysis of information associated with the passenger that has been captured from at least one of the social media platform, the newscast, or the published document over the communication network 112. Prior to executing the one or more types of verifications, the second processor 216 may retrieve the one or more types of documents from the database server 110 that are required for executing the one or more types of verifications. In case the one or more types of documents are unavailable in the database server 110, the second processor 216 may request the passenger to provide the one or more types of documents. After retrieving the one or more types of documents, the second processor 216 may execute the one or more types of verifications at the one or more trigger points. In an embodiment, the second processor 216 may validate the one or more types of documents of the passenger based on information received from the one or more reliable sources, such as the vendor server 108. Based on pass or failure of the validation of the one or more types of verifications, the second processor 216 stores the verification information of the passenger in the database server 110.

After extracting the verification information of the passenger from the database server 110, the second processor 216 renders the second user interface 234 on the second display 232 of the driver device 104 over the communication network 112. The second user interface 234 presents at least the verification information of the passenger and the plurality of options selectable by the driver to perform the one or more actions. The second processor 216 further receives the third request from the third transceiver 228 by way of the second transceiver 218 over the communication network 112. The second processor 216 processes the third request to determine the preference of the driver. Based on the determined preference, the second processor 216 performs one or more defined operations. For example, the second processor 216 allocates the selected vehicle to the passenger, when the determined preference of the driver is associated with the first option. The second processor 216 selects another vehicle from the set of vehicles available for the ride, when the determined preference of the driver is associated with the second option. The second processor 216 performs the re-verification of the passenger, when the determined preference of the driver is associated with the third option.

The second transceiver 218 includes suitable logic, circuitry, and/or interfaces that are operable to transmit (or receive) data to (or from) various devices, such as the third transceiver 228 over the communication network 112. For example, the second transceiver 218 receives the one or more requests, such as the third request, from the third transceiver 228 over the communication network 112. The second transceiver 218 further transmits the one or more interfaces, such as the second user interface 234, to the third transceiver 228 over the communication network 112. The second transceiver 218 further transmits the passenger information to the third transceiver 228 over the communication network 112. The second transceiver 218 communicates with the third transceiver 228 using various wired and wireless communication protocols, such as TCP/IP (Transmission Control Protocol/Internet Protocol), UDP (User Datagram Protocol), 2^{nd} Generation (2G), 3^{rd} Generation (3G), 4^{th} Generation (4G) communication protocols, or any combination thereof.

The second memory 220 includes suitable logic, circuitry, and/or interfaces to store the one or more instructions that are executed by the second processor 216 to perform the one or more operations. The second memory 220 further stores the one or more types of documents of the passenger for executing the one or more types of verifications. The second memory 220 further stores the one or more requests, such as the third request. The second memory 220 further stores the verification information of the passenger. The second memory 220 further stores the passenger information of the passenger.

Referring now to FIG. 3A, a block diagram that illustrates the first user interface 210 of FIG. 2A is shown, in accordance with an embodiment of the present invention. The first user interface 210 is rendered by the second processor 216 on the first display 208 of the passenger device 102 in response to the received first request. The first user interface 210 includes one or more sections, such as a first section 302a, a second section 304a, and a third section 306a.

The first section 302a includes driver information of the driver of the selected vehicle, such as a name, an image, a contact number, or a driver rating of the driver. The second section 304a includes the verification information of the driver, such as the one or more types of verifications, the verification status of the one or more types of verifications, and the verification time of the one or more types of verifications. The one or more types of verifications may be associated with the verifications, such as the identity verification, the criminal record verification, the background verification, a court record verification, a police verification, or the like. The one or more types of verifications may further be associated with the verifications of the one or more types of documents, such as the PAN, the driving license, the passport, the address proof, or the like of the driver. In an embodiment, the second processor 216 may be configured to execute the one or more types of verifications at the one or more trigger points, and stores the verification status of the one or more types of verifications in the database server 110. In another embodiment, the second processor 216 may execute the one or more types of verifications in real-time after the reception of the first request from the passenger device 102, and stores the verification status of the one or more types of verifications in the database server 110. The verification status of the one or more types of verifications may be indicated by the pass or failure of the validation of the one or more types of documents associated with the one or more types of verifications. The verification time of the one or more types of verifications may indicate one or more time instances (e.g., a last verification time) at which the one or more types of verifications for the driver had been executed by the second processor 216. The third section 306a includes the plurality of options, such as an accept booking tab 308a, a reject booking tab 310a, and a re-verify tab 312a. The accept booking tab 308a corresponds to the acceptance of the selected vehicle for the allocation. The reject booking tab 310a corresponds to the rejection of the selected vehicle for the allocation. The re-verify tab 312a corresponds to the re-verification of the driver of the selected vehicle before the allocation. The plurality of options allow the passenger to provide the preference for the selected vehicle based on the verification information of the driver. For example, the passenger provides the input by means of the first I/O port 212 to select at least one of the accept booking tab 308a, the reject booking tab 310a, or the re-verify tab 312a. Based on the selected tab, the first processor 202 transmits the second request to the second processor 216 over the communication network 112. The second processor 216 processes the second request, and determines the preference of the passenger. Based on the determined preference of the passenger, the second processor 216 allocates the vehicle to the passenger. For example, the second processor 216 allocates the selected vehicle to the passenger, when the determined preference of the passenger is in accordance with the accept booking tab 308a. In another example, the second processor 216 selects another vehicle from the set of vehicles for the allocation, when the determined preference of the passenger is in accordance with the reject booking tab 310a. In yet another example, the second processor 216 executes the re-verification of the driver, when the determined preference of the passenger is in accordance with the re-verify tab 312a. The second processor 216 renders the re-verified verification information of the driver on the first user interface 210 that is presented on the first display 208. Based on the re-verified verification information of the driver, the passenger may further select one of the plurality of options to provide the preference for the requested booking request.

Referring now to FIG. 3B, a block diagram that illustrates the second user interface 234 of FIG. 2B is shown, in accordance with an embodiment of the present invention. The second user interface 234 is rendered by the second processor 216 on the second display 232 of the driver device 104 associated with the driver of the selected vehicle in response to the received first request. The second user interface 234 includes one or more sections, such as a first section 302b, a second section 304b, and a third section 306b.

The first section 302b includes passenger information of the passenger, such as a name, an image, a contact number, or a passenger rating of the passenger. The second section 304b includes the verification information of the passenger, such as the one or more types of verifications, the verification status of the one or more types of verifications, and the verification time of the one or more types of verifications. The one or more types of verifications may be associated with the verifications, such as the identity verification, the criminal record verification, the background verification, a court record verification, a police verification, or the like. The one or more types of verifications may further be associated with the verifications of the one or more types of documents, such as the PAN, the passport, the address proof, and the like of the passenger. In an embodiment, the second processor 216 may be configured to execute the one or more types of verifications at the one or more trigger points, and stores the verification status of the one or more types of verifications in the database server 110. In another embodiment, the second processor 216 may execute the one or more types of verifications in real-time after the reception of the first request from the passenger device 102, and stores the verification status of the one or more types of verifications in the database server 110. The verification status of the one or more types of verifications may be indicated by the pass or failure of the validation of the one or more types of documents associated with the one or more types of verifications. The verification time of the one or more types of verifications may indicate the one or more time instances (e.g., a last verification time) at which the one or more types of verifications for the passenger had been executed by the second processor 216. The third section 306b includes the plurality of options, such as an accept booking tab 308b, a reject booking tab 310b, and a re-verify tab 312b. The accept booking tab 308b corresponds to the acceptance of the selected vehicle for the allocation. The reject booking tab 310b corresponds to the rejection of the selected vehicle for the allocation. The re-verify tab 312b corresponds to the re-verification of the passenger before the allocation. The plurality of options are selectable by the driver to provide the preference for the allocation based on the verification information of the passenger. For example, the driver provides the input by means of the third I/O port 236 to select at least one of the accept booking tab 308b, the reject booking tab 310b, or the re-verify tab 312b. Based on the selection, the third processor 226 transmits the third request to the second processor 216 over the communication network 112. The second processor 216 processes the third request, and determines the preference of the driver. Based on the determined preference of the driver, the second processor 216 allocates the vehicle to the passenger. For example, the second processor 216 allocates the selected vehicle to the passenger, when the determined preference of the driver is in accordance with the accept booking tab 308a. In another example, the second processor 216 selects another vehicle for the allocation, when the determined preference of the driver is in accordance with the reject booking tab 310a. In yet another example, the second processor 216 executes the re-verification of the passenger, when the determined preference of the driver is in accordance with the re-verify tab 312a. The second processor 216 further renders the re-verified verification information of the passenger on the second user interface 234 that is presented on the second display 232. Based on the re-verified verification information of the passenger, the driver may further select one of the plurality of options to provide the preference for the requested booking request by the passenger.

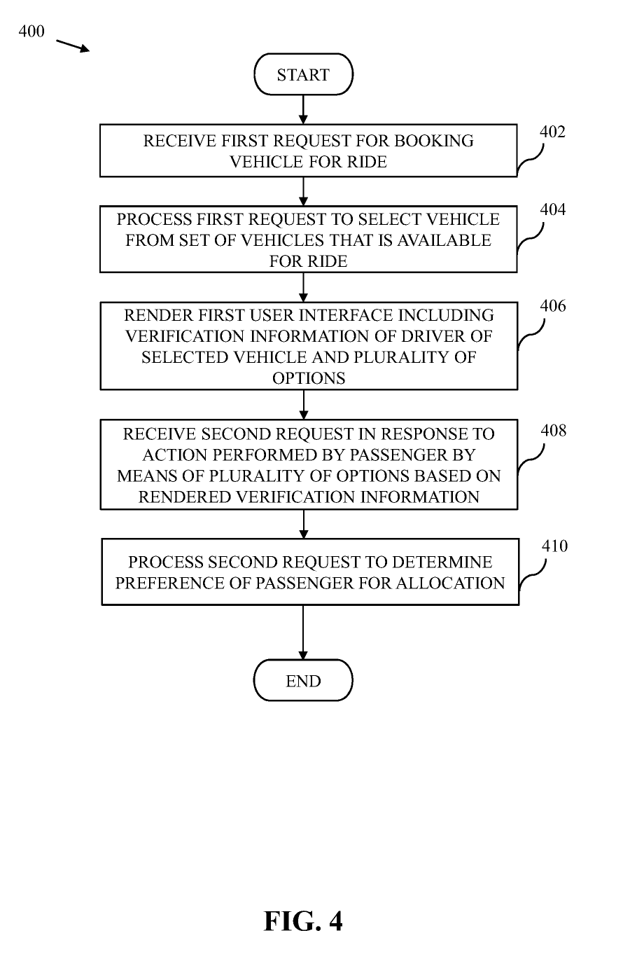

Referring now to FIG. 4, a flow chart 400 that illustrates a method for allocating the vehicle to the passenger is shown, in accordance with an embodiment of the present invention.

At step 402, the second transceiver 218 receives the first request from the first transceiver 204 over the communication network 112. The passenger provides the input corresponding to the first request by means of the first I/O port 212, and the first processor 202 transmits the first request by way of the first transceiver 204 to the second transceiver 218 over the communication network 112. The second transceiver 218 stores the first request in the second memory 220.

At step 404, the second processor 216 retrieves the first request from the second memory 220, and processes the first request to select the vehicle from the set of vehicles that is available for the ride. The second processor 216 selects the vehicle from the set of vehicles, which may be within a defined vicinity of the pick-up address of the source location (either captured from the passenger device 102 or provided by the passenger).

At step 406, the second processor 216 renders the first user interface 210 on the first display 208 of the passenger device 102 based on the selected vehicle from the set of vehicles. The first user interface 210 includes the driver information and the verification information of the driver of the selected vehicle. The first user interface 210 further includes the plurality of options for performing the action by the passenger based on the displayed information i.e., the driver or verification information.

At step 408, the second transceiver 218 receives the second request from the first transceiver 204 over the communication network 112. The passenger selects one of the plurality of options by means of the first I/O port 212 based on at least one of the rendered driver or verification information, and the first processor 202 transmits the second request in response to the selection by way of the first transceiver 204 to the second transceiver 218 over the communication network 112. The second request indicates the preference of the passenger for the selected vehicle. The second transceiver 218 stores the second request in the second memory 220.

At step 410, the second processor 216 retrieves the second request from the second memory 220, and processes the second request to determine the preference of the passenger for the selected vehicle. Based on the determined preference, the second processor 216 determines the allocation of the vehicle to the passenger. For example, the second processor 216 allocates the selected vehicle to the passenger, when the determined preference indicates the acceptance of the selected vehicle for the allocation by the passenger. Further, the second processor 216 selects another vehicle from the set of vehicles available for the ride, when the determined preference indicates the rejection of the selected vehicle for the allocation by the passenger. Further, the second processor 216 executes the re-verification of the driver of the selected vehicle, when the determined preference of the passenger indicates the request for the re-verification of the driver. Such method of allocating the vehicle allows the passenger to provide his (or her) preference for the driver of the selected vehicle based on the verification information (such as the criminal record, fraud, background, or identity verifications) of the driver, and hence, the vehicle is allocated based on the preference of the passenger that optimizes safety and trust of the passenger during the ride. Further, such method of allocating the vehicle that optimizes the safety and trust of the passenger during the ride may encourage other individuals to use the vehicle services, thereby increasing the footfall of the passengers, which creates more job opportunities for the drivers.

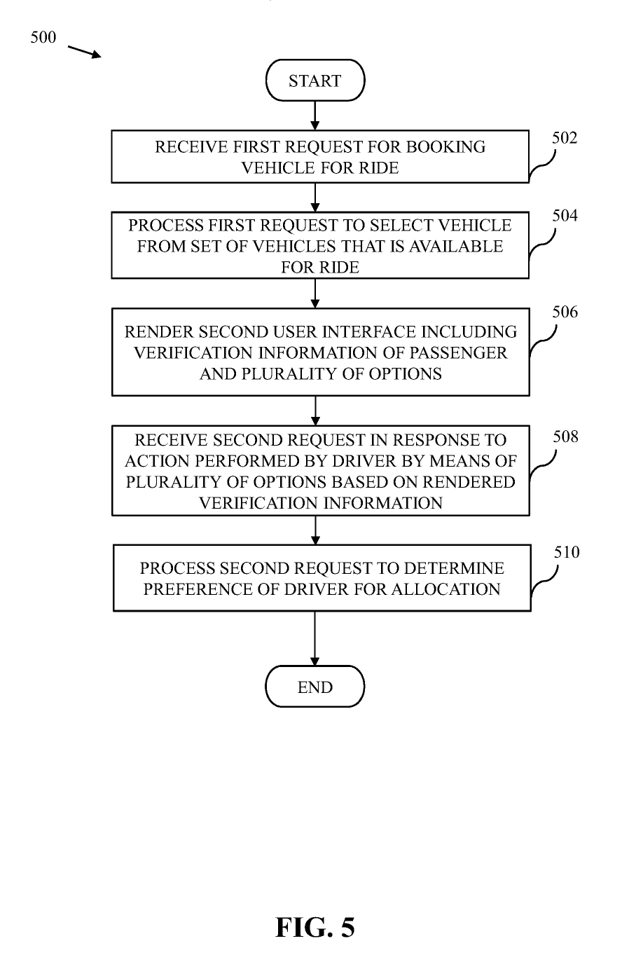

Referring now to FIG. 5, a flow chart 500 that illustrates a method for allocating the vehicle to the passenger is shown, in accordance with another embodiment of the present invention.

At step 502, the second transceiver 218 receives the first request from the first transceiver 204 over the communication network 112. The passenger provides the input corresponding to the first request by means of the first I/O port 212, and the first processor 202 transmits the first request by way of the first transceiver 204 to the second transceiver 218 over the communication network 112. The second transceiver 218 stores the first request in the second memory 220.

At step 504, the second processor 216 retrieves the first request from the second memory 220, and processes the first request to select the vehicle from the set of vehicles that is available for the ride. The second processor 216 selects the vehicle from the set of vehicles, which may be within the defined vicinity of the pick-up address of the source location (either captured from the passenger device 102 or provided by the passenger).

At step 506, the second processor 216 renders the second user interface 234 on the second display 232 of the driver device 104 of the driver of the selected vehicle from the set of vehicles. The second user interface 234 includes the passenger information and the verification information of the passenger. The second user interface 234 further includes the plurality of options for performing the action by the driver based on the displayed information i.e., the passenger or verification information.

At step 508, the second transceiver 218 receives the third request from the third transceiver 228 over the communication network 112. The driver selects one of the plurality of options by means of the third I/O port 236 based on at least one of the rendered passenger or verification information, and the third processor 226 transmits the third request in response to the selection by way of the third transceiver 228 to the second transceiver 218 over the communication network 112. The third request indicates the preference of the driver for the allocation. The second transceiver 218 stores the third request in the second memory 220.

At step 510, the second processor 216 retrieves the third request from the second memory 220, and processes the third request to determine the preference of the driver for the allocation. Based on the determined preference, the second processor 216 determines the allocation of the vehicle to the passenger. For example, the second processor 216 allocates the selected vehicle to the passenger, when the determined preference indicates the acceptance of the selected vehicle for the allocation by the driver. Further, the second processor 216 selects another vehicle from the set of vehicles available for the ride, when the determined preference indicates the rejection of the selected vehicle for the allocation by the driver. Further, the second processor 216 executes the re-verification of the passenger, when the determined preference of the driver indicates the request for the re-verification of the passenger. Such method of allocating the vehicle allows the driver to provide his (or her) preference for the passenger based on the verification information (such as the criminal record, fraud, background, or identity verifications) of the passenger, and hence, the vehicle is allocated based on the preference of the driver that optimizes safety and trust of the driver during the ride.

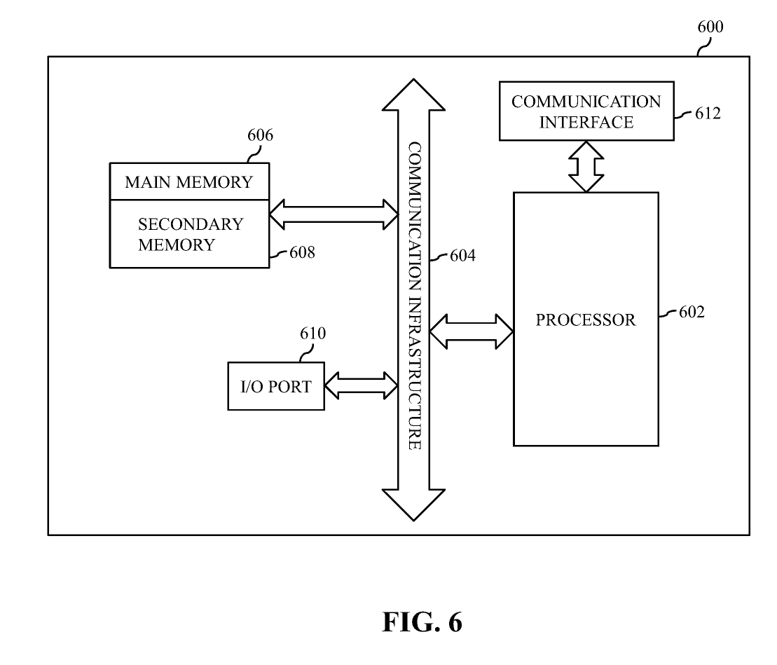

Referring now to FIG. 6, a block diagram that illustrates a computer system 600 for allocating the vehicle to the passenger is shown, in accordance with an embodiment of the present invention. An embodiment of the present invention, or portions thereof, may be implemented as computer readable code on the computer system 600. In one example, the application server 106, the vendor server 108, and the database server 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

The computer system 600 includes a processor 602 that may be a special purpose or a general purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 112, multi-core message-passing scheme, and the like. The computer system 600 further includes a main memory 606 and a secondary memory 608. Examples of the main memory 606 may include random access memory (RAM), read-only memory (ROM), and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 further includes an input/output (I/O) port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the communication network 112 which may be configured to transmit the signals to the various devices that are communicatively coupled to the computer system 600. Examples of the communication channel may include, but are not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the methods illustrated in FIGS. 4 and 5. In an embodiment, the present invention is implemented using a computer implemented application. The computer implemented application may be stored in a computer program product and loaded into the computer system 600 using the removable storage drive or the hard disc drive in the secondary memory 608, the I/O port 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 602, and a memory, such as the main memory 606 and the secondary memory 608, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for allocating the vehicle to the passenger. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for allocating vehicles to passengers for optimizing safety and trust of the passengers during rides, the method comprising:
receiving, by circuitry from a passenger device of a passenger over a communication network, a first request for booking a ride;
processing, by the circuitry, the first request to select a vehicle from a set of vehicles available for the ride;
rendering, by the circuitry on a display of the passenger device over the communication network, a user interface including verification information of a driver of the selected vehicle and a plurality of options selectable by the passenger;
receiving, by the circuitry from the passenger device over the communication network, a second request in response to a selection by the passenger by means of the plurality of options, based on the verification information rendered on the user interface; and
processing, by the circuitry, the second request to determine a preference of the passenger, wherein the selected vehicle is allocated to the passenger based on the determined preference that optimizes the safety and trust of the passenger during the ride.

2. The method of claim 1, wherein the verification information comprises at least one or more types of verifications, a verification status of each of the one or more types of verifications, or a verification time of each of the one or more types of verifications.

3. The method of claim 2, wherein the one or more types of verifications comprise at least one of an identity verification, a criminal record verification, or a background verification.

4. The method of claim 2, further comprising executing, by the circuitry, the one or more types of verifications at one or more trigger points, wherein the one or more trigger points comprise at least one of a first trigger point that is detected based on a registration of the driver on a vehicle transit platform providing vehicle services to the passenger, a second trigger point that is detected based on a change in geo-fence of the driver, a third trigger point that is detected after a first interval of time based on historical feedback of the driver, a fourth trigger point that is detected after a second interval of time based on demographic data of the driver, a fifth trigger point that is detected after a third interval of time based on a fraud or criminal history of the driver, a sixth trigger point that is detected based on a rating of the driver and the demographic data, or a seventh trigger point that is detected based on analysis of information associated with the driver that has been captured from at least one of a social media platform, a newscast, or an electronic document.

5. The method of claim 4, wherein the one or more types of verifications are executed based on one or more types of documents of the driver, wherein the one or more types of documents are captured based on the one or more trigger points prior to the execution of the one or more types of verifications.

6. The method of claim 1, wherein the plurality of options on the user interface comprise at least two options from a first option, a second option or a third option, wherein the first option corresponds to an acceptance of the selected vehicle for the allocation, the second option corresponds to a rejection of the selected vehicle for the allocation, and the third option corresponds to a request for re-verification of the driver.

7. The method of claim 6, wherein the selected vehicle is allocated to the passenger for the ride when the determined preference of the passenger is associated with the first option, wherein another vehicle is selected from the set of vehicles available for the ride when the determined preference of the passenger is associated with the second option, and wherein the driver of the selected vehicle is re-verified when the determined preference of the passenger is associated with the third option.

8. A method for allocating vehicles to passengers for optimizing safety and trust of drivers during rides, the method comprising:
receiving, by circuitry from a passenger device of a passenger over a communication network, a first request for booking a ride;
processing, by the circuitry, the first request to select a vehicle from a set of vehicles available for the ride;
rendering, by the circuitry on a display of a driver device of a driver of the selected vehicle over the communication network, a user interface including verification information of the passenger and a plurality of options selectable by the driver;
receiving, by the circuitry from the driver device over the communication network, a second request in response to a selection by the driver by means of the plurality of options, based on the verification information rendered on the user interface; and
processing, by the circuitry, the second request to determine a preference of the driver, wherein the selected vehicle is allocated to the passenger based on the determined preference that optimizes the safety and trust of the driver during the ride.

9. The method of claim 8, wherein the verification information comprises at least one or more types of verifications, a verification status of each of the one or more types of verifications, or a verification time of each of the one or more types of verifications.

10. The method of claim 9, wherein the one or more types of verifications comprise at least one of an identity verification, a criminal record verification, or a background verification.

11. The method of claim 9, further comprising executing, by the circuitry, the one or more types of verifications at one or more trigger points, wherein the one or more trigger points comprise at least one of a first trigger point that is detected based on a registration of the passenger on a vehicle transit platform providing vehicle services to the passenger, a second trigger point that is detected based on a change in geo-fence of the passenger, a third trigger point that is detected after a first interval of time based on historical feedback of the passenger, a fourth trigger point that is detected after a second interval of time based on demographic data of the passenger, a fifth trigger point that is detected after a third interval of time based on a fraud or criminal history of the passenger, a sixth trigger point that is detected based on a rating of the passenger and the demographic data, or a seventh trigger point that is detected based on analysis of information associated with the passenger that has been captured from at least one of a social media platform, a newscast, or an electronic document.

12. The method of claim 11, wherein the one or more types of verifications are executed based on one or more types of documents of the passenger, wherein the one or more types of documents are captured based on the one or more trigger points prior to the execution of the one or more types of verifications.

13. The method of claim 8, wherein the plurality of options on the user interface comprise at least two options from a first option, a second option or a third option, wherein the first option corresponds to an acceptance of the selected vehicle for the allocation, the second option corresponds to a rejection of the selected vehicle for the allocation, and the third option corresponds to a request for re-verification of the passenger.

14. The method of claim 13, wherein the selected vehicle is allocated to the passenger for the ride when the determined preference of the driver is associated with the first option, wherein another vehicle is selected from the set of vehicles available for the ride when the determined preference of the driver is associated with the second option, and wherein the passenger is re-verified when the determined preference of the driver is associated with the third option.

15. A system for allocating vehicles to passengers for optimizing safety and trust of the passengers during rides, the system comprising:
circuitry configured to:
receive, from a passenger device of a passenger over a communication network, a first request for booking a ride;
process the first request to select a vehicle from a set of vehicles available for the ride;
render, on a display of the passenger device over the communication network, a user interface including verification information of a driver of the selected vehicle and a plurality of options selectable by the passenger;
receive, from the passenger device over the communication network, a second request in response to a selection by the passenger by means of the plurality of options, based on the verification information rendered on the user interface; and
process the second request to determine a preference of the passenger, wherein the selected vehicle is allocated to the passenger based on the determined preference that optimizes the safety and trust of the passenger during the ride.

16. The system of claim 15, wherein the verification information comprises at least one or more types of verifications, a verification status of each of the one or more types of verifications, or a verification time of each of the one or more types of verifications.

17. The system of claim 16, wherein the one or more types of verifications comprise at least one of an identity verification, a criminal record verification, or a background verification.

18. The system of claim 16, wherein the circuitry is further configured to execute the one or more types of verifications at one or more trigger points, wherein the one or more trigger points comprise at least one of a first trigger point that is detected based on a registration of the driver on a vehicle transit platform providing vehicle services to the passenger, a second trigger point that is detected based on a change in geo-fence of the driver, a third trigger point that is detected after a first interval of time based on historical feedback of the driver, a fourth trigger point that is detected after a second interval of time based on demographic data of the driver, a fifth trigger point that is detected after a third interval of time based on a fraud or criminal history of the driver, a sixth trigger point that is detected based on a rating of the driver and the demographic data, or a seventh trigger point that is detected based on analysis of information associated with the driver that has been captured from at least one of a social media platform, a newscast, or an electronic document.

19. The system of claim 15, wherein the plurality of options on the user interface comprise at least two options from a first option, a second option or a third option, wherein the first option corresponds to an acceptance of the selected vehicle for the allocation, the second option corresponds to a rejection of the selected vehicle for the allocation, and the third option corresponds to a request for re-verification of the driver.

20. The system of claim 19, wherein the selected vehicle is allocated to the passenger for the ride when the determined preference of the passenger is associated with the first option, wherein another vehicle is selected from the set of vehicles available for the ride when the determined preference of the passenger is associated with the second option, and wherein the driver of the selected vehicle is re-verified when the determined preference of the passenger is associated with the third option.
